(19) United States
(12) Patent Application Publication
(10) Pub. No.: US 2024/0157259 A1
(43) Pub. Date: May 16, 2024

(54) STARTING RAMP FOR TUBING TRACKS

(71) Applicant: Team Service S.r.l., Novara (IT)

(72) Inventor: Manuel Guenzi, Novara (IT)

(21) Appl. No.: 18/085,168

(22) Filed: Dec. 20, 2022

(30) Foreign Application Priority Data
Nov. 15, 2022 (IT) 102022000023478

(51) Int. Cl. A63G 21/12

(52) U.S. Cl. CPC A63G 21/12

(57) ABSTRACT

A starting ramp for tubing tracks suitable for making the start of a tubing donut easier, comprising a lever system suitable for lifting the starting element and a lever system activation device for gradually lifting the starting element and an activation device housed within a control console.

### OBJECT OF THE INVENTION

The object of this invention is a starting ramp for tubing tracks, suitable for rendering the start of a tubing donut easier.

### Present Status of the Art

Tubing, also known as inner tubing, bumper tubing, towed tubing, or kite tubing, is a recreational activity that is made on top of an inner tube shaped like a donut, which is made on water, on snow, or through the air. The tubes are also known as “donuts” or “biscuits” because of their shape.

The case of snow tubing, born in alpine mountains, is of interest in the present case. Snow tubing is a winter activity similar to sledding. This type of tubing is almost always made on a hill or a slope, by taking advantage of the force of gravity to push a user on top of the “donut” downhill. Often the user comes back to the top of the slope with his/her “donut” to repeat the process. The small amount of friction between most of a “donut” and snow makes it possible to reach considerable speeds while running, especially on steep slopes.

Some ski stations offer courses exclusively dedicated to tubing. Such courses are often provided with peripheral barriers in order to guide the “donuts” along a safe path.

Summer tubing is the summer variant of snow tubing. In this case, the “donuts” slide on artificial tracks, usually made of a special plastic. These tracks can be installed in the mountains by ski stations or might be also located in amusement parks.

The tubing practice presently known has a number of drawbacks, in particular in the areas organized for tubing, which will be also referred to as “tracks” or “tubing tracks”.

The scope of the present invention is basically dedicated to said areas organized for tubing. In said areas, the start of a user on top of a “donut” is assisted by an operator who pushes the user a little bit beyond the start of the slope, while leaving it as soon as he/she gains speed.

In the tubing practice, it is also usual that a number of users challenge each other in competitions, with the goal of reaching the bottom of the slope first, all of them starting simultaneously. In order to implement such a type of start, in the areas equipped for tubing, it is necessary that the individual operators operate in order for all users to start gaining speed simultaneously, an operation that is not easy to perform if made manually.

In order to overcome the drawbacks of the present status of the art, in particular: (i) to eliminate the physical effort operators shall make to push a user a little bit beyond the start of the slope; and (ii) to make the users being in competition gain speed simultaneously, while preventing any users from accidentally starting before the previous user, who started his/her downhill before, moves away from the following one by a distance enough to prevent any collision with the next one, for this reason a ramp according to the present invention has been created.

### DESCRIPTION OF THE INVENTION

In order to solve the above-mentioned problems, a starting ramp for tubing tracks has been created, provided with an element featuring a flat surface suitable for making a tubing donut slide, shortly also referred to below as “starting element” or simply “element”. The rear part of said starting element is lifted by means of a lever system, the levers being operatable by means of a first activation device which gradually lifts the rear portion of the starting element. Said first activation device being housed within a control console.

In one embodiment, at least one roller is present in the flat surface of the starting element, whereas said starting element is formed of a set of rollers parallel to each other in another embodiment, Each roller is installed in such a way as to rotate around its own central axis in order to facilitate the sliding of the tubing “donut”, while giving further speed to said “donut”.

In a further embodiment, each roller is suitable for rotation with respect to its own central axis being in neutral or handled by means of one or more first handling devices; just as an example, said first handling devices might be actuators. Said first handling devices of each roller are actuated by a second activation device placed alternatively in a position outside the control console or in the control console.

As indicated above, among the problems encountered in the present status of the art, it is very important to prevent a user from accidentally starting before the previous user, who already started his/her downward movement, moves away by a distance enough to prevent any collision between the two users. As a matter of fact, it is theoretically possible that the user accidentally started is faster than the user who precedes him/her, which implies a risk of a collision between the two users. In order to prevent this risk, the ramp according to the present invention is provided with a safety barrier placed at the end of the frontal portion of the starting element facing the slope.

The safety barrier is lowered by means of one or more second handling devices actuated by a third activation device placed alternatively outside the control console or in the control console.

In the ramp according to the present invention, the handling activation devices of the lever system and the safety barrier are actuated by one dedicated operator. Note that operators responsible for getting an orderly and organized influx of users are present in tracks equipped for tubing. Said operators are also responsible for putting into operation the handling activation devices of the lever system and the safety barrier, which the ramp according to the present invention is equipped with, thus enabling individual users on top of their tubing “donuts” to start and move downhill.

As indicated in the previous paragraph, another problem of the prior art to be solved is providing a simultaneous start of users that challenge each other in tubing competitions with the goal of reaching the bottom of slope first.

In order to obtain such type of start, in the prior art the operators shall operate simultaneously and push users in such a way that all of them gain speed simultaneously, an operation that is not easy to achieve if performed manually.

In order to obviate such drawback, the ramp according to the present invention is provided with a synchronization device for a simultaneous activation of all activation devices which the ramp according to the present invention is provided with.

The synchronization device is actuated by a fourth activation device alternatively positioned outside the control console or present in the control console.

The synchronization device actuated by the fourth activation device activates the activation devices of the handling devices of the ramps on which the users being in competition are present, simultaneously.

In order to appreciate the advantages achieved by the ramp according to the present invention in an easier way, the operating modes of the subject ramp are also illustrated below.

In its rest position, the starting element of the ramp has a slope ranging from 0° to 5°. Whenever an operator actuates the activation devices that lift the rear portion of the starting element, the rear part of the starting element starts lifting in order to assume a tilted position suitable for making the tubing “donut” start, up to reaching a max. slope of 90°.

### DESCRIPTION OF THE FIGURES

FIG. 1 shows a starting ramp (1) for tubing tracks according to the present invention in its rest position, the starting element (2) having a flat surface suitable for making a tubing “donut” and a safety barrier (7) placed in the frontal portion (B) of the starting element (2) start. The safety barrier (7) is lowered by means of one or more second handling devices (9) actuated by a third activation device (10), not shown in the figure, placed alternatively outside the control console (c) or in the control console (c), not shown in the figure.

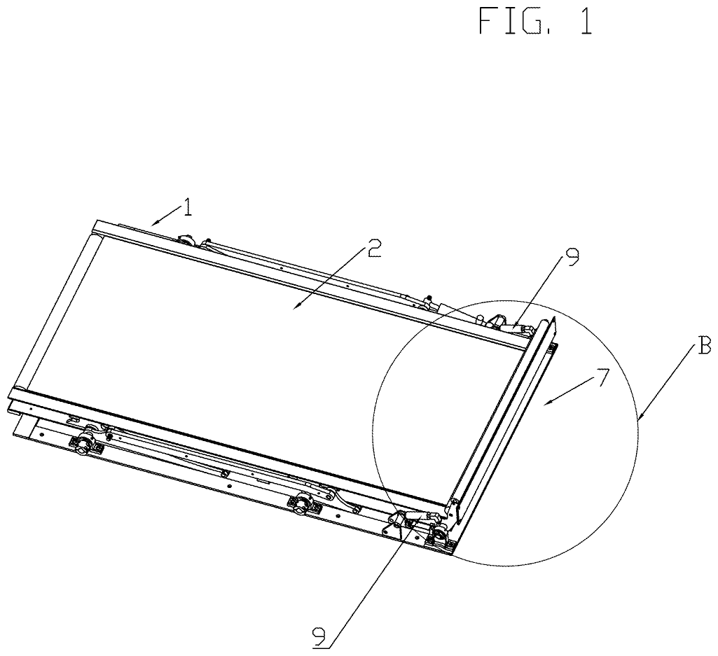

FIG. 2 shows a lever system (3) suitable for gradually lifting the rear portion (A) of the starting element (2) of the ramp (2). The lever system (3) is actuated by a first activation device (4), not shown in the figure, housed within a control console (c) also not shown in the figure. The ramp according to the present invention also comprises a starting element (2) having a flat surface suitable for making a tubing “donut” provided with at least one roller (6) suitable for rotating around its own axis, not shown in the figures, slide.

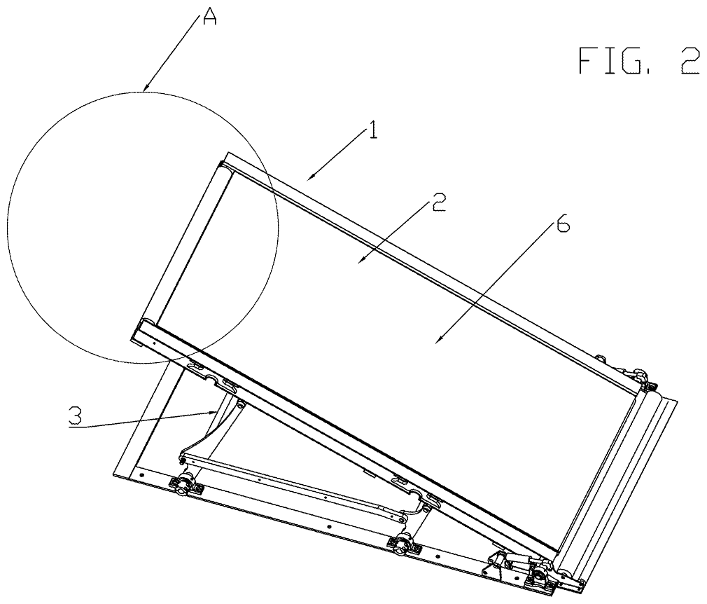

FIG. 3 shows the starting element (2) formed of a set of rollers (6) parallel to each other.

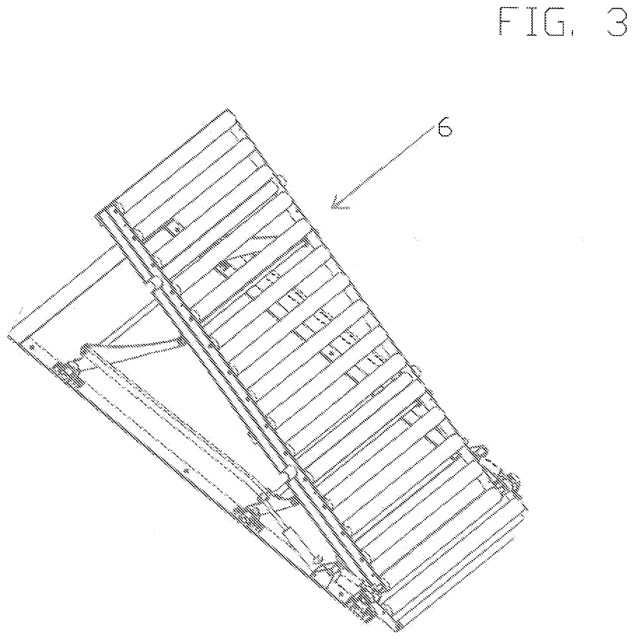

Each roller (6) rotates around its own central axis being in neutral or by means of one or more second handling devices (8), not shown in the figures, actuated by a second activation device (5), not shown in the figures, placed alternatively outside the control console (e) or in the control console (c), not shown in the figures.

The starting ramp (1) for tubing tracks is also provided with a synchronization device (11), not shown in the figures, suitable for actuating the above mentioned activation devices of two or more ramps (1) in a synchronized manner, which is actuated by a fourth activation device (12), not shown in the figures, placed outside the control console (c) or in the control console (c), not shown in the figures.

1. A starting ramp (1) for tubing tracks characterized in that it comprises a starting element (2) having a flat surface suitable for sliding a tubing donut, a lever system (3) suitable for lifting the rear portion (A) of the starting element (2), a first activation device (4) of the lever system (3) for gradual lifting of the rear portion (A) of the starting element (2) and said first activation device (4) being housed within a control console (c).

2. A starting ramp (1) for tubing tracks according to claim 1 characterized in that the flat surface suitable for sliding a tubing donut of the starting element (2) is provided with at least one roller (6) suitable for rotating around its central axis.

3. A starting ramp (1) for tubing tracks according to claim 1 characterized in that the starting element (2) is provided with a safety barrier (7) located in the frontal portion (B) of the starting element (2).

4. A starting ramp (1) for tubing tracks according to claim 2 characterized in that each roller (6) is suitable to rotate around its central axis being in neutral or by means of one or more first handling devices (8) of the roller (6) actuated by a second activation device (5) placed alternatively in a position outside the control console (c) or in the control console (c).

5. A starting ramp (1) for tubing tracks according to claim 3 characterized in that the safety barrier (7) is lowered by means of one or more second handling devices (9) actuated by a third activation device (10) positioned alternatively outside the control console (c) or in the control console (c).

6. A starting ramp (1) for tubing tracks according to claim 1 characterized of being provided with a synchronization device (11) suitable for synchronously activating the activation devices of two or more starting ramps (1) which is activated by a fourth activation device (12) positioned alternatively outside the control console (c) or in the control console (c).
